(19) United States
(12) Patent Application Publication
(10) Pub. No.: US 2026/0024012 A1
(43) Pub. Date: Jan. 22, 2026

(54) SECURITY FOR REMOTELY-DEPLOYED ARTIFICIAL INTELLIGENCE (AI) MODELS

(71) Applicant: HEWLETT PACKARD ENTERPRISE DEVELOPMENT LP, Spring, TX (US)

(72) Inventors: Andrew Longworth, Boeblingen (DE); Glyn Bowden, Bristol (GB); Rohini Chavakula, Bangalore (IN)

(21) Appl. No.: 18/911,874

(22) Filed: Oct. 10, 2024

(30) Foreign Application Priority Data
Jul. 18, 2024 (IN) 202441054950

(51) Int. Cl. G06N 20/00

(52) U.S. Cl. CPC G06N 20/00

(57) ABSTRACT

Systems and methods are provided for providing additional security for a remotely-deployed artificial intelligence (AI) model. For example, the method may comprise receiving a container with an AI model, a certificate, and an executor component, where training of the AI model occurs at a first location and the AI model is provided to a second location. The method may deploy the AI model at the second location and automatically determine, by the executor component, validity of the certificate associated with the AI model. Upon determining that the certificate is invalid, the method may automatically initiate an action on the AI model at the second location independent of the device at the first location.

### BACKGROUND

Artificial intelligence (AI) models have many uses, including image detection, natural language processing, and prediction tasks. Some machine learning models perform these operations using a training process. For example, the AI model may be trained to recognize data features in input and generate an output prediction or label based on a confidence score that correlates the data feature to the particular label.

### BRIEF DESCRIPTION OF THE DRAWINGS

The present disclosure, in accordance with one or more various embodiments, is described in detail with reference to the following figures. The figures are provided for purposes of illustration only and merely depict typical or example embodiments.

FIG. 1 illustrates a first device, second device, model registry, certificate authority, and authorization authority, in accordance with some examples of the present disclosure.

FIG. 2 provides an illustrative container, in accordance with some examples of the present disclosure.

FIG. 3 illustrates a signing process for the AI model stored in a container, in accordance with some examples of the present disclosure.

FIG. 4 provides an illustrative structure/process of the container with the AI model, in accordance with some examples of the present disclosure.

FIG. 5 is an illustrative process for verifying the validity of the signed AI model, in accordance with some examples of the present disclosure.

FIG. 6 is an example process that may be used to implement various features of embodiments described in the present disclosure.

FIG. 7 is an example computing component that may be used to implement various features of embodiments described in the present disclosure.

The figures are not exhaustive and do not limit the present disclosure to the precise form disclosed.

### DETAILED DESCRIPTION

AI models are commonly trained at a first location and deployed at a second location. For example, in the medical space, the AI model may be trained by a first data center and transmitted to a second data center for deployment for a medical imaging system. In defense and policing sectors, the AI model may be remotely-deployed with facial recognition features to identify persons of interest. However, the training data set may become out-of-date while the AI model is deployed at the second location, so any use of the AI model may create inaccurate inferences for being out-of-date as well.

Traditional systems may simply download a new AI model when the model becomes outdated. However, the first location and the second location may not maintain a connection between the two locations. For example, the AI model may be provided as a temporary service (e.g., software as a service or “SaaS”) or the second location may redirect/remove the connection as part of data center management to move the system offline. Also, since the two locations may not share a connection, it may be difficult or unavailable to update the model or retrain the model with the new data at the first location after the model is deployed at the second location.

Examples of the improved systems and method implement security processes to help ensure the AI model is valid for a period of time and also maintain the ability to invalidate the AI model (e.g., when the training data becomes outdated, or without a connection between the two locations). The invalidation of the AI model may be implemented in various ways, for example, after an expiration period or by receiving a signal of a change in state from another device/user in the environment.

The improved systems and method may first sign the AI model at the first location. In this initial signing process, the system at the first location may use code-signing or artefact signing with asymmetrical encryption in the form of a public/private keypair. For example, the system may generate the AI model (or “original artefact,” used interchangeably) and execute a hash function to generate a fingerprint or hash of the AI model. The private key may be encrypted and a signature may be added with a timestamp and certification. The signed AI model (or “signed artefact,” used interchangeably) may be published for access by the system at the second location.

The AI model container may comprise, for example, an executor component embedded in the container and the certificate. For example, once the AI model is generated and signed at the first location, executor component may self-execute machine instructions to check the validity of the certificate before allowing execution of the AI model to continue at the second location. The software associated with the signed AI model may check the validity of the signed AI model. For example, executor component may check the validity and expiration of the AI model when it is launched. If online, a web-based public key infrastructure can be used with a certificate authority established at the AI model or artefact repository at the first location or at the second location. When offline, the certificate can be generated by a local sub certificate authority (e.g., at the second location) with delegated rights that sets a short expiration time on the certificate. This ensures that the certificate will expire, meaning a check on the AI model state will need to be performed before issuing a new, valid certificate.

If the certificate is expired, the executor component can perform a number of actions. For example, the action may comprise continuing execution for a pre-defined period of time, defined in hours or days. This would give time for an offline system to be connected to a network to refresh the certificate without causing a disruption in service. The action may comprise halting processing immediately and alert that the certificate needs to be refreshed to continue. The action may comprise deleting the model within the container so that a new one will need to be deployed along with a certificate. The action may comprise deleting the contents of the container, executor component, and AI model, and then halt the container.

Technical improvements are described throughout the disclosure, including improved data security and pre-validation of AI models before inference/use of the AI model at a remote location. When the AI model is encrypted, the AI model remains encrypted when the certificate is expired so that even with physical access to the device at the second location, the AI model or data is not at risk of snooping.

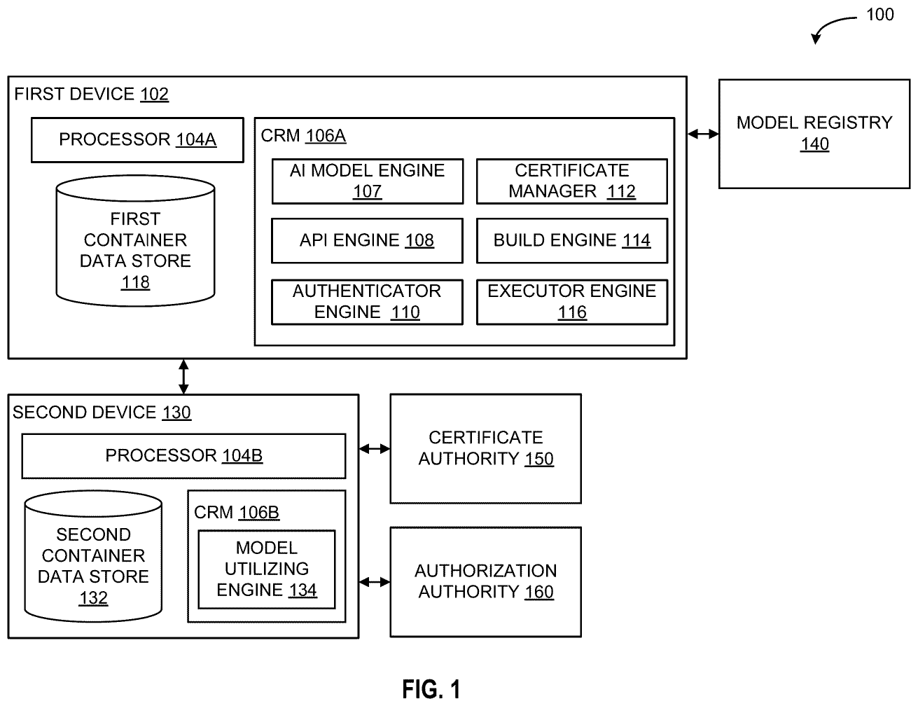

FIG. 1 illustrates a first device, second device, model registry, certificate authority, and authorization authority, in accordance with some examples of the present disclosure. In example 100, various devices are shown including first device 102, second device 130, model registry 140, certificate authority 150, and authorization authority 160. First device 102 and second device 130 each comprise processor 104 (illustrated as first processor 104A at first device 102 and second processor 104B at second device 130) and computer readable media 106 (illustrated as first computer readable media 106A at first device 102 and second computer readable media 106B at second device 130).

Processor 104 may be implemented using a general-purpose or special-purpose processing engine such as, for example, a microprocessor, controller, or other control logic. Processor 104 may be connected to a bus, although any communication medium can be used to facilitate interaction with other components of the corresponding device that embeds processor 104 or to communicate externally.

Computer readable media 106 may be implemented as random-access memory (RAM) or other dynamic memory, to be used for storing information and instructions to be executed by processor 104. Other memory might also be used for storing temporary variables or other intermediate information during execution of instructions to be executed by processor 104 or a read only memory (“ROM”) or other static storage device coupled to the bus for storing static information and instructions for processor 104.

Computer readable media 106 may comprise various engines and modules to be executed by processor 104. For example, at first user device 102, computer readable media 106A may comprise AI model engine 107, API engine 108, authenticator engine 110, certificate manager 112, build engine 114, and executor engine 116. The AI models and corresponding metadata may be stored in first container data store 118 at first device 102. At second user device 130, computer readable media 106B may comprise model utilizing engine 134. The received AI models and corresponding metadata may be stored in second container data store 132 at second device 130.

AI model engine 107 is configured to identify an AI model. In some examples, the AI model is received from an external data source and not trained by AI model engine 107. Instead, AI model engine 107 may receive a trained AI model that is pre-configured to generate the response and a confidence score by applying a plurality of data as input, and the AI model may generate the response and confidence score.

In other examples, AI model engine 107 may generate and train an AI model. For example, the AI model may be trained to generate the response and a confidence score by applying a plurality of data as input, and the AI model may generate the response and confidence score. The training process may first preprocess the plurality of data, including a data formatting process, where the software code files are converted from different software code file types (e.g., image format, Word® format, etc.) into a unified digital format (e.g., PDF file). The preprocessing may also include data extraction to help segment the data that may be irrelevant. The data extraction may discard/extract information, for example using optical character recognition (“OCR”) and natural language processing (NLP) techniques.

The training process may implement feature extraction on the data. For example, once the preprocessing of the data is initiated, the input may be broken down into smaller units or tokens during a tokenization process. These tokens could be words, subwords, or characters, depending on the tokenization scheme used by the model. The feature extraction may also include an embedding lookup process, where embeddings are generated as high-dimensional vector representations of the tokens. These embeddings may correspond with semantic and syntactic properties of the tokens and mathematical relationships between the tokens.

In some examples, the feature extraction process may encode the embeddings for the individual tokens using transformers or recurrent neural networks. Using these encodings, the feature extraction process may extract relevant features from the encoded representations by transforming the encoded representations into feature vectors. In some examples, the feature extraction process may reduce the dimensionality of the extracted features using a dimensionality reduction technique (e.g., Principal Component Analysis (“PCA”) or t-distributed Stochastic Neighbor Embedding (“t-SNE”), etc.).

In some examples, the feature extraction process may normalize or scale the feature vectors (e.g., z-score normalization or min-max scaling, etc.) to create consistent ranges and distributions for the extracted features. When normalization is incorporated with the feature extraction process, normalization can help prevent features with large magnitudes from dominating the learning process and ensure that the model can effectively learn from the input data.

In some examples, the feature extraction process may implement feature selection (e.g., technique like filtering or wrapper methods), discard irrelevant or redundant features, and generate an output. The output of the feature selection process may be used as input to downstream tasks, such as classification, regression, sequence generation, or generating output text for the model based on the learned patterns and relationships in the input data. As illustrative examples, the training may comprise a cross-entropy loss to classify the input data, and a mean squared error for regression tasks.

AI model engine 107 is also configured to generate a confidence score with the output/inference. Various processes may be implemented to generate the confidence score associated with the response, including a Naive Bayes classifier, logistic regression, neural network based structured prediction, natural language understanding. In some examples, a set of responses are generated and the response with the highest confidence score may be provided to the user interface where the AI model is deployed (e.g., at second device 130).

The AI model may take various forms. For example, the AI model may correspond with deep learning, logistics, random forest, linear regression, naïve Bayes, support vector machines (“SVM”), supervised/unsupervised learning, and others. The type of model may be determined based on the task where the AI model is used at second device 130.

API engine 108 is configured to provide access to the AI model. For example, input may be transmitted via API engine 108 and API engine 108 may provide a response (e.g., AI model inference/output). In some examples, API engine 108 is configured to limit access to AI model including whether the executed code will allow the AI model to be accessed or not. In some examples, access may be permitted via API engine 108 and executor engine 116 may stop the AI model from functioning or generating inferences/output.

Authenticator engine 110 is configured to sign the AI model at first device 102 and/or at the first location. In this signing process, authenticator engine 110 may use code-signing or artefact signing with asymmetrical encryption in the form of a public/private keypair. For example, the system may generate the AI model (or “original artefact,” used interchangeably) and execute a hash function to generate a fingerprint or hash of the AI model. The private key may be encrypted and a signature may be added with a timestamp and certification. The signed AI model (or “signed artefact,” used interchangeably) may be published for access by the system at the second location.

Certificate manager 112 is configured to manage the certificates deployed by certificate authority 150. In some examples, certificate manager 112 is configured to receive, analyze, monitor, and manage the certificates.

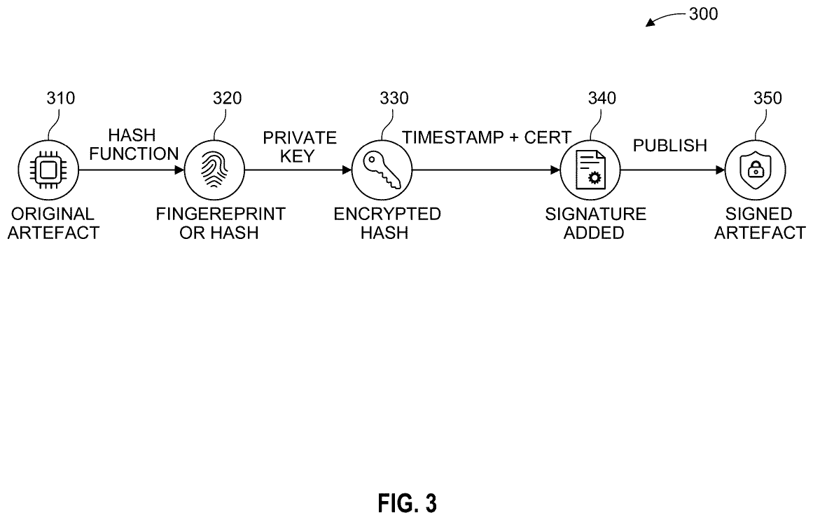

Build engine 114 is configured to generate or build the container with various components, including a model artefact or AI model, a certificate, and an executor component. Additional detail of generating a signed artefact is illustrated in FIG. 3.

Executor engine 116 is configured to ensure the AI model is valid for a period of time and also maintain the ability to invalidate the AI model (e.g., when the training data becomes outdated, or without a connection between the two locations). The invalidation of the AI model may be implemented in various ways, for example, after an expiration period or by receiving a signal of a change in state from another device/user in the environment. In some examples, the expiration period is determined prior to receiving the AI model at the second location (e.g., during initialization or model generation at first device 102).

In some examples, executor engine 116 is embedded in a container as an executor component. The executor component may be stored in the container with a certificate (e.g., generated by certificate manager 112). For example, once the AI model is generated (e.g., by AI model engine 107) and signed, the executor component may self-execute machine instructions to check the validity of the certificate before allowing execution of the AI model to continue.

In some examples, executor engine 116 (or executor component stored in a container) may check the validity of the signed AI model. For example, the embedded executor component may check the validity and expiration of the AI model when it is launched. If online, a web-based public key infrastructure can be used with a certificate authority established at the AI model or artefact repository at the first location or at the second location. When offline, the certificate can be generated by a local sub certificate authority (e.g., at the second location) with delegated rights that sets a short expiration time on the certificate. This ensures that the certificate will expire, meaning a check on the AI model state will need to be performed before issuing a new, valid certificate.

In some examples, the expiry of the AI model is based on a lifespan of the certificate. For example, when the certificate associated with the AI model (e.g., stored in the container) is no longer valid, the AI model may also expire automatically. The automatic expiration may be based on executor engine 116 confirming that the certificate is valid prior to permitting access to the AI model.

In some examples, executor engine 116 (or executor component stored in a container) is configured to automatically initiate an action. For example, the action may be initiated on the AI model once the AI model is deployed at the second location. When executor engine 116 is implemented as an executor component of a container that comprises the AI model, the action may be automatically initiated independent of first device 102 at the first location.

The action may be implemented in various ways. For example, the action may comprise continuing execution of the AI model at second device 130 for a pre-defined period of time, defined in hours or days. This may give time for an offline system (e.g., second device 130) to be connected to a network to refresh the certificate (e.g., from certificate authority 150, authorization authority 160, or first device 102) without causing a disruption in service.

In some examples, the action may comprise halting or stopping processing of the AI model immediately and alert that the certificate needs to be refreshed to continue. In some examples, the alert may be transmitted to a user interface of second device 130. The alert may comprise a notification that the certificate associated with the AI model is invalid.

In some examples, the action may comprise deleting the AI model within the container. Executor component stored in container (or executor component 116) may delete the AI model by executing computer readable instructions that delete the AI model. In some examples, deleting the existing AI model may enable a new AI model to be deployed along with a certificate.

In some examples, the action may comprise deleting the contents of the container, executor component, and AI model, and then halt/stop execution of the container. Executor component stored in container (or executor component 116) may delete the AI model by executing computer readable instructions that delete the container.

Second device 130 comprises computer readable media 106B and model utilizing engine 134. For example, second device 130 is configured to receive the AI model from first device 102 and store the AI model in second container data store 132. In some examples, the AI model may be stored in a container (e.g., stored in second container data store 132) and the container may comprise the AI model, a certificate, and an executor component.

Second device 130 may be located at a second location. The second location can correspond with various environments, including a hospital, data center, edge location, manufacturing plant, or other locations, without diverting from the scope of the disclosure.

Model utilizing engine 134 is configured to deploy the AI model at second container data store 132 and second location. Various implementations are possible. For example, when second device 130 is a magnetic resonance imaging (“MRI”) machine or high-energy electromagnetic radiation (“X-ray”) machine, second device 130 may implement an AI model to perform the image processing or inference functions of the captured digital image. When the AI model is deactivated or otherwise inaccessible, second device 130 may continue to operate (e.g., in generating digital images, etc.) yet may not perform the inference functions associated with the AI model.

In some examples, there may be a validation process to confirm that the AI model is operational and usable. If the AI model is signed (e.g., as a signed artefact), the AI model may start running only when the cryptographic token is valid or authorized to function. In these examples, the executor component of the container may allow or restrict operation of the AI model.

Model registry 140 is configured to provide an AI model to first device 102. In some examples, model registry 140 provide the AI model and first device 102 may store the AI model in first container data store 118. In some examples, build engine 114 may receive the AI model from model registry 140 and package it together in the container.

Certificate authority 150 is configured to digitally sign and publish a public key bound to a given user, in a process that can validate identities associated with devices (e.g., first device 102 and second device 130). Certificate authority 150 may store a private key corresponding with the public key. A digital certificate can be issued to bind the entities to the cryptographic keys. In some examples, the certificate provides authentication (e.g., by serving as a credential to validate the identity of the entity that it is issued to), encryption (e.g., for secure communication over insecure networks), and integrity (e.g., of the AI model that is signed with the certificate so that they cannot be altered by a third party in transit).

Authorization authority 160 is configured to grant access to a set of resources, for example, an API or data and restrict actions of what second device 130 can perform on AI model or other data on behalf of first device 102.

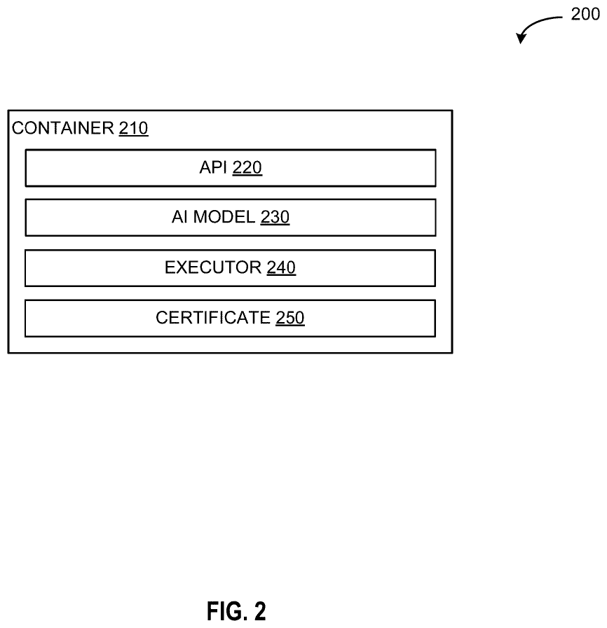

FIG. 2 provides an illustrative container, in accordance with some examples of the present disclosure. In example 200, container 210 is illustrated, which comprises API 220, AI model 230, executor 240, and certificate 250. Container 210 may be generated by first device 102 and transmitted to second device 130, as illustrated in FIG. 1. In some examples, the features of API engine 108, AI model engine 107, executor engine 116, and certificate manager 112 in FIG. 1 are implemented as API 220, AI model 230, executor 240, and certificate 250 in FIG. 2, respectively.

FIG. 3 illustrates a signing process for the AI model stored in a container, in accordance with some examples of the present disclosure. In example 300, a signing process for the AI model may comprise various operations illustrated herein.

At block 310, the process may receive an original AI model (or “the original artifact,” used interchangeably). The original AI model may be generated by first device 102 in FIG. 1.

At block 320, the process may execute a hash function on the original AI model to generate a hash value or digital fingerprint of the original AI model.

At block 330, the process may generate an encrypted hash. Various encryption algorithms may be implemented, including public key infrastructure (PKI). The encrypted hash may be generated using a private key and the hash value from block 320.

At block 340, the process may provide the encrypted hash to a certificate authority. The certificate authority may generate a certificate of the encrypted hash.

In some examples, a timestamp may be published with the AI model and the certificate. The timestamp may be used with determining the validity of the certificate.

At block 350, the process may publish the AI model with the certificate. In some examples, the AI model with the certificate is considered a signed artefact of the AI model. The signed artefact may be transmitted from first device 102 in FIG. 1 to second device 130 in FIG. 1 to, for example, generate inferences of input data at second device 130.

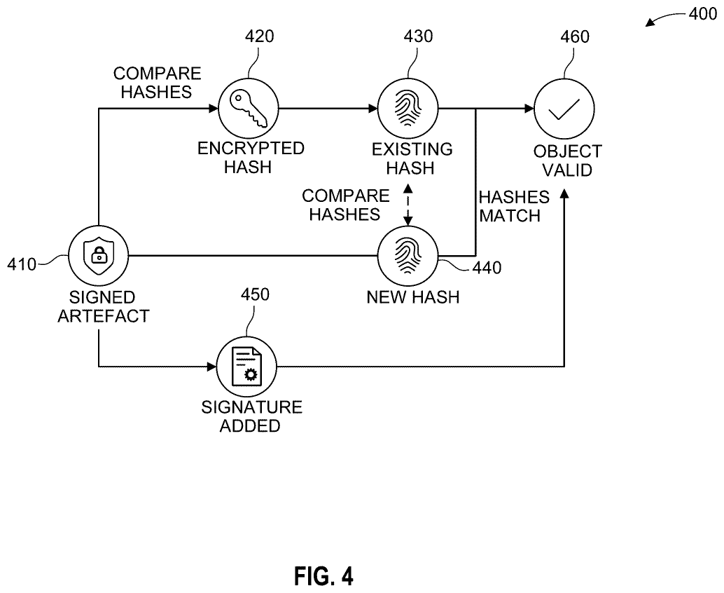

FIG. 4 provides an illustrative structure/process of the container with the AI model, in accordance with some examples of the present disclosure. In example 400, the signed artefact of the AI model may be received at second device 130 in FIG. 1 at block 410.

At block 420, the process may comprise determining the encrypted hash associated with the received signed artefact.

At block 430, an existing/stored hash may be compared with the encrypted hash value associated with the received signed artefact. When the hash values match, the AI model may be unchanged and, at block 460, the signed artefact may be valid.

At block 440, an existing/stored hash may be compared with the encrypted hash value associated with the received signed artefact. When the hash values do not match, the AI model may be changed and updated. At block 460, the signed artefact may be valid as being associated with the update AI model. The certificate associated with the AI model may be unlocked and the AI model may updated at second device 130 in FIG. 1, which is the location where the AI model has been deployed.

At block 450, the process comprises a new signature added to the container associated with the received AI model/signed artefact. In some examples, a new hash value (block 440) is also associated with issuing a new certificate.

In some examples, second device 130 may request a new certificate from the original source (e.g., certificate authority 150) with the same hash key. If that certificate is generated, the process may update the AI model at second device 130. If the certificate is not generated, the process may stop/halt until the new certificate is received.

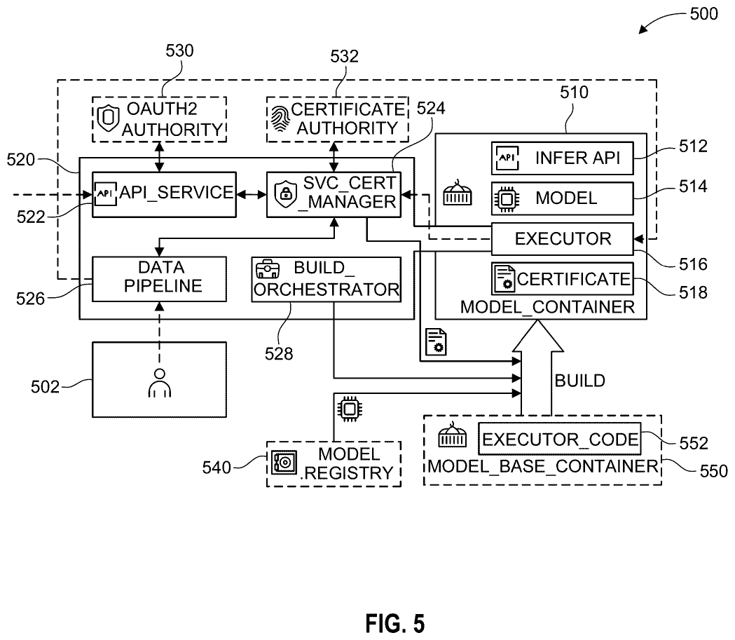

FIG. 5 is an illustrative process 500 for verifying the validity of the signed AI model, in accordance with some examples of the present disclosure. For example, at block 502, a user associated with a first device may initiate a process to replace an AI model executed/deployed at a second device. The process may, for example, sign and deploy a new AI model at the second device by triggering/initiating process that causes the model to be signed and then pushing the new AI model to the second device or other location where the container is running the previous AI model.

At block 510, components of the container are illustrated. The components may comprise, API 512, AI model 514, executor component 516, and certificate 518. In some examples, API 512, AI model 514, executor component 516, and certificate 518 correspond with the features of API engine 108, AI model engine 107, executor engine 116, and certificate manager 112 in FIG. 1, respectively, or API 220, AI model 230, executor 240, and certificate 250 in FIG. 2, respectively.

At block 520, the executor component comprises various features that perform the provisioning. For example, the executor component may comprise API service manager 522, service certificate manager 524, data pipeline 526, and build orchestrator 528.

At block 530, authorization authority may grant or restrict access to a set of resources, for example, an API or data, as discussed herein.

At block 532, certificate authority may provision the certificate and sign the original artefact to create a signed artefact of the AI model, as discussed herein.

At block 540, model registry is configured to provide/track the AI model, as discussed herein.

At block 550, model base container is illustrated, which comprises executor code at block 552. The model base container may store an original AI model that can be retrained or resigned to generate an updated AI model, as discussed herein.

It should be noted that the terms “optimize,” “optimal” and the like as used herein can be used to mean making or achieving performance as effective or perfect as possible. However, as one of ordinary skill in the art reading this document will recognize, perfection cannot always be achieved. Accordingly, these terms can also encompass making or achieving performance as good or effective as possible or practical under the given circumstances, or making or achieving performance better than that which can be achieved with other settings or parameters.

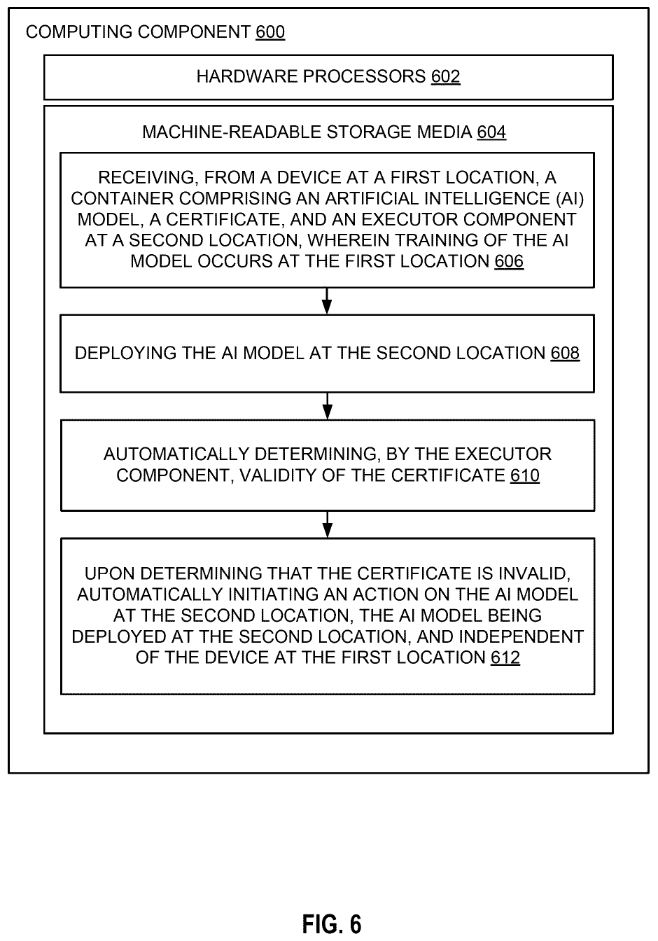

FIG. 6 illustrates an example computing component that may be used to implement burst preloading for available bandwidth estimation in accordance with various embodiments. Computing component 600 may be, for example, a server computer, a controller, or any other similar computing component capable of processing data. In the example implementation of FIG. 6, computing component 600 includes hardware processor 602 and machine-readable storage medium 604.

Hardware processor 602 may be one or more central processing units (CPUs), semiconductor-based microprocessors, and/or other hardware devices suitable for retrieval and execution of instructions stored in machine-readable storage medium 604. Hardware processor 602 may fetch, decode, and execute instructions, such as instructions 606-612, to control processes or operations for burst preloading for available bandwidth estimation. As an alternative or in addition to retrieving and executing instructions, hardware processor 602 may include one or more electronic circuits that include electronic components for performing the functionality of one or more instructions, such as a field programmable gate array (FPGA), application specific integrated circuit (ASIC), or other electronic circuits.

A machine-readable storage medium, such as machine-readable storage medium 604, may be any electronic, magnetic, optical, or other physical storage device that contains or stores executable instructions. Thus, machine-readable storage medium 604 may be, for example, Random Access Memory (RAM), non-volatile RAM (NVRAM), an Electrically Erasable Programmable Read-Only Memory (EEPROM), a storage device, an optical disc, and the like. In some embodiments, machine-readable storage medium 604 may be a non-transitory storage medium, where the term “non-transitory” does not encompass transitory propagating signals. As described in detail below, machine-readable storage medium 604 may be encoded with executable instructions, for example, instructions 606-612.

Hardware processor 602 may execute instruction 606 to receive, from a device at a first location, a container comprising an artificial intelligence (AI) model, a certificate, and an executor component at a second location. The training of the AI model may occur at the first location.

In some examples, the container may comprise, for example, an executor component embedded in the container, the AI model itself, and the certificate. In some examples, the AI model may take various forms, including a deep learning model, logistics, random forest, linear regression, naïve Bayes, support vector machine (“SVM”), supervised/unsupervised learning, and others.

Hardware processor 602 may execute instruction 608 to deploy the AI model at the second location. The AI model may be deployed with the certificate at the second location. In some examples, once the AI model is generated and signed at the first location, executor component may self-execute machine instructions to check the validity of the certificate before allowing execution of the AI model to continue at the second location.

The deployment of the AI model may correspond with various environments. For example, in the medical space, the AI model may be trained by a first data center and transmitted to a second data center for deployment for a medical imaging system. In defense and policing sectors, the AI model may be remotely-deployed with facial recognition features to identify persons of interest.

Hardware processor 602 may execute instruction 610 to automatically determine, by the executor component, validity of the certificate. For example, the executor component may check the validity of the signed AI model when the executor component is launched. If online, a web-based public key infrastructure can be used with a certificate authority established at the AI model or artefact repository at the first location or at the second location. When offline, the certificate can be generated by a local sub certificate authority (e.g., at the second location) with delegated rights that sets a short expiration time on the certificate. This ensures that the certificate will expire, meaning a check on the AI model state will need to be performed before issuing a new, valid certificate.

Hardware processor 602 may execute instruction 612 to automatically initiate an action on the AI model at the second location. The action may be initiated upon determining that the certificate is invalid. For example, if the certificate is expired, the action may comprise continuing execution for a pre-defined period of time, defined in hours or days. This would give time for an offline system to be connected to a network to refresh the certificate without causing a disruption in service. The action may comprise halting processing immediately and alert that the certificate needs to be refreshed to continue. The action may comprise deleting the AI model within the container so that a new one will need to be deployed along with a certificate. The action may comprise deleting the contents of the container, executor component, and AI model, and then halt the container. Other actions are available without diverting from the essence of the disclosure.

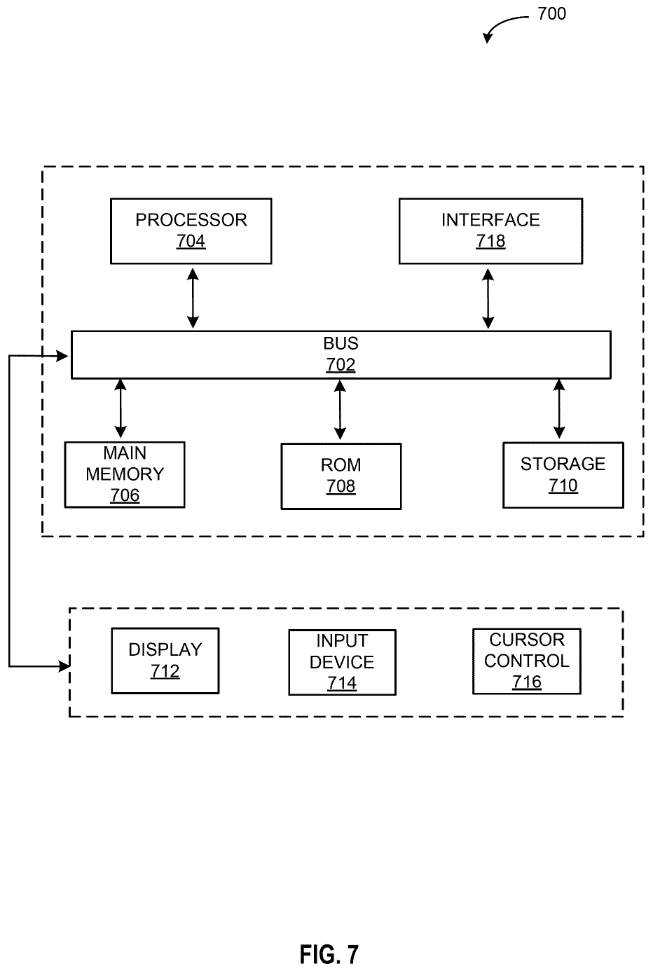

FIG. 7 depicts a block diagram of an example computer system 700 in which various the embodiments described herein may be implemented. The computer system 700 includes a bus 702 or other communication mechanism for communicating information, one or more hardware processors 704 coupled with bus 702 for processing information. Hardware processor(s) 704 may be, for example, one or more general purpose microprocessors.

The computer system 700 also includes a main memory 706, such as a random access memory (RAM), cache and/or other dynamic storage devices, coupled to bus 702 for storing information and instructions to be executed by processor 704. Main memory 706 also may be used for storing temporary variables or other intermediate information during execution of instructions to be executed by processor 704. Such instructions, when stored in storage media accessible to processor 704, render computer system 700 into a special-purpose machine that is customized to perform the operations specified in the instructions.

The computer system 700 further includes a read only memory (ROM) 708 or other static storage device coupled to bus 702 for storing static information and instructions for processor 704. A storage device 710, such as a magnetic disk, optical disk, or USB thumb drive (Flash drive), etc., is provided and coupled to bus 702 for storing information and instructions.

The computer system 700 may be coupled via bus 702 to a display 712, such as a liquid crystal display (LCD) (or touch screen), for displaying information to a computer user. An input device 714, including alphanumeric and other keys, is coupled to bus 702 for communicating information and command selections to processor 704. Another type of user input device is cursor control 716, such as a mouse, a trackball, or cursor direction keys for communicating direction information and command selections to processor 704 and for controlling cursor movement on display 712. In some embodiments, the same direction information and command selections as cursor control may be implemented via receiving touches on a touch screen without a cursor.

The computing system 700 may include a user interface module to implement a GUI that may be stored in a mass storage device as executable software codes that are executed by the computing device(s). This and other modules may include, by way of example, components, such as software components, object-oriented software components, class components and task components, processes, functions, attributes, procedures, subroutines, segments of program code, drivers, firmware, microcode, circuitry, data, databases, data structures, tables, arrays, and variables.

In general, the word “component,” “engine,” “system,” “database,” data store,” and the like, as used herein, can refer to logic embodied in hardware or firmware, or to a collection of software instructions, possibly having entry and exit points, written in a programming language, such as, for example, Java, C or C++. A software component may be compiled and linked into an executable program, installed in a dynamic link library, or may be written in an interpreted programming language such as, for example, BASIC, Perl, or Python. It will be appreciated that software components may be callable from other components or from themselves, and/or may be invoked in response to detected events or interrupts. Software components configured for execution on computing devices may be provided on a computer readable medium, such as a compact disc, digital video disc, flash drive, magnetic disc, or any other tangible medium, or as a digital download (and may be originally stored in a compressed or installable format that requires installation, decompression or decryption prior to execution). Such software code may be stored, partially or fully, on a memory device of the executing computing device, for execution by the computing device. Software instructions may be embedded in firmware, such as an EPROM. It will be further appreciated that hardware components may be comprised of connected logic units, such as gates and flip-flops, and/or may be comprised of programmable units, such as programmable gate arrays or processors.

The computer system 700 may implement the techniques described herein using customized hard-wired logic, one or more ASICs or FPGAs, firmware and/or program logic which in combination with the computer system causes or programs computer system 700 to be a special-purpose machine. According to one embodiment, the techniques herein are performed by computer system 700 in response to processor(s) 704 executing one or more sequences of one or more instructions contained in main memory 706. Such instructions may be read into main memory 706 from another storage medium, such as storage device 710. Execution of the sequences of instructions contained in main memory 706 causes processor(s) 704 to perform the process steps described herein. In alternative embodiments, hard-wired circuitry may be used in place of or in combination with software instructions.

The term “non-transitory media,” and similar terms, as used herein refers to any media that store data and/or instructions that cause a machine to operate in a specific fashion. Such non-transitory media may comprise non-volatile media and/or volatile media. Non-volatile media includes, for example, optical or magnetic disks, such as storage device 710. Volatile media includes dynamic memory, such as main memory 706. Common forms of non-transitory media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge, and networked versions of the same.

Non-transitory media is distinct from but may be used in conjunction with transmission media. Transmission media participates in transferring information between non-transitory media. For example, transmission media includes coaxial cables, copper wire and fiber optics, including the wires that comprise bus 702. Transmission media can also take the form of acoustic or light waves, such as those generated during radio-wave and infra-red data communications.

The computer system 700 also includes interface 718 coupled to bus 702. Interface 718 provides a two-way data communication coupling to one or more network links that are connected to one or more local networks. For example, interface 718 may be an integrated services digital network (ISDN) card, cable modem, satellite modem, or a modem to provide a data communication connection to a corresponding type of telephone line. As another example, interface 718 may be a local area network (LAN) card to provide a data communication connection to a compatible LAN (or WAN component to communicate with a WAN). Wireless links may also be implemented. In any such implementation, interface 718 sends and receives electrical, electromagnetic or optical signals that carry digital data streams representing various types of information.

A network link typically provides data communication through one or more networks to other data devices. For example, a network link may provide a connection through local network to a host computer or to data equipment operated by an Internet Service Provider (ISP). The ISP in turn provides data communication services through the world wide packet data communication network now commonly referred to as the “Internet.” Local network and Internet both use electrical, electromagnetic or optical signals that carry digital data streams. The signals through the various networks and the signals on network link and through interface 718, which carry the digital data to and from computer system 700, are example forms of transmission media.

The computer system 700 can send messages and receive data, including program code, through the network(s), network link and interface 718. In the Internet example, a server might transmit a requested code for an application program through the Internet, the ISP, the local network and interface 718.

The received code may be executed by processor 704 as it is received, and/or stored in storage device 710, or other non-volatile storage for later execution.

Each of the processes, methods, and algorithms described in the preceding sections may be embodied in, and fully or partially automated by, code components executed by one or more computer systems or computer processors comprising computer hardware. The one or more computer systems or computer processors may also operate to support performance of the relevant operations in a “cloud computing” environment or as a “software as a service” (SaaS). The processes and algorithms may be implemented partially or wholly in application-specific circuitry. The various features and processes described above may be used independently of one another, or may be combined in various ways. Different combinations and sub-combinations are intended to fall within the scope of this disclosure, and certain method or process blocks may be omitted in some implementations. The methods and processes described herein are also not limited to any particular sequence, and the blocks or states relating thereto can be performed in other sequences that are appropriate, or may be performed in parallel, or in some other manner. Blocks or states may be added to or removed from the disclosed example embodiments. The performance of certain of the operations or processes may be distributed among computer systems or computers processors, not only residing within a single machine, but deployed across a number of machines.

As used herein, a circuit might be implemented utilizing any form of hardware, software, or a combination thereof. For example, one or more processors, controllers, ASICs, PLAS, PALs, CPLDs, FPGAs, logical components, software routines or other mechanisms might be implemented to make up a circuit. In implementation, the various circuits described herein might be implemented as discrete circuits or the functions and features described can be shared in part or in total among one or more circuits. Even though various features or elements of functionality may be individually described or claimed as separate circuits, these features and functionality can be shared among one or more common circuits, and such description shall not require or imply that separate circuits are required to implement such features or functionality. Where a circuit is implemented in whole or in part using software, such software can be implemented to operate with a computing or processing system capable of carrying out the functionality described with respect thereto, such as computer system 700.

As used herein, the term “or” may be construed in either an inclusive or exclusive sense. Moreover, the description of resources, operations, or structures in the singular shall not be read to exclude the plural. Conditional language, such as, among others, “can,” “could,” “might,” or “may,” unless specifically stated otherwise, or otherwise understood within the context as used, is generally intended to convey that certain embodiments include, while other embodiments do not include, certain features, elements and/or steps.

Terms and phrases used in this document, and variations thereof, unless otherwise expressly stated, should be construed as open ended as opposed to limiting. Adjectives such as “conventional,” “traditional,” “normal,” “standard,” “known,” and terms of similar meaning should not be construed as limiting the item described to a given time period or to an item available as of a given time, but instead should be read to encompass conventional, traditional, normal, or standard technologies that may be available or known now or at any time in the future. The presence of broadening words and phrases such as “one or more,” “at least,” “but not limited to” or other like phrases in some instances shall not be read to mean that the narrower case is intended or required in instances where such broadening phrases may be absent.

What is claimed is:

1. A method comprising:
receiving, from a device at a first location, a container comprising an artificial intelligence (AI) model, a certificate, and an executor component at a second location, wherein training of the AI model occurs at the first location;
deploying the AI model at the second location;
automatically determining, by the executor component, validity of the certificate; and
upon determining that the certificate is invalid, automatically initiating an action on the AI model at the second location, the AI model being deployed at the second location, and independent of the device at the first location.

2. The method of claim 1, wherein the executor component determines that the certificate is invalid after an expiration period, and wherein the expiration period is determined prior to receiving the AI model at the second location.

3. The method of claim 1, further comprising:
receiving, by the executor component, a signal of a change in state from the device at the first location; and
determining that the certificate is invalid based on the signal of the change in state.

4. The method of claim 1, wherein the AI model is generated at the first location by:
receiving an original AI model;
executing a hash function on the original AI model to generate a hash value;
generating an encrypted hash using a private key and the hash value;
providing the encrypted hash to a certificate authority to generate a certificate of the encrypted hash; and
publishing the AI model with the certificate.

5. The method of claim 4, wherein the AI model and the certificate are published with a timestamp, and wherein the timestamp is used with determining the validity of the certificate.

6. The method of claim 1, wherein the action comprises continuing access to the AI model for a pre-defined period of time at the second location.

7. The method of claim 1, wherein the action comprises stopping processing immediately and transmitting a notification that the certificate is invalid.

8. The method of claim 1, wherein the action comprises deleting the AI model by the executor component absent deleting other contents in the container.

9. The method of claim 1, wherein the action comprises deleting the AI model and the executor component, and halting the container.

10. A method comprising:
receiving, by a first device at a first location, an original AI model that is previously trained to generate inferences;
executing, by the first device, a hash function on the original AI model to generate a hash value;
generating an encrypted hash using a private key and the hash value;
providing the encrypted hash to a certificate authority to generate a certificate of the encrypted hash; and
publishing and providing, by the first device to a second device at a second location, the AI model with the certificate.

11. The method of claim 10, wherein the second device is configured to initiate an action on the AI model at the second location by:
receiving, by the second device, an executor component that determines whether the certificate is invalid after an expiration period; and
upon determining that the certificate is valid, deploying the AI model at the second location.

12. The method of claim 11, further comprising:
receiving, by the executor component, a signal of a change in state from the device at the first location; and
determining that the certificate is invalid based on the signal of the change in state.

13. A network device comprising:
a memory storing instructions; and
a processor communicatively coupled to the memory and configured to execute the instructions to:
receive, from a second device at a first location, a container comprising an artificial intelligence (AI) model, a certificate, and an executor component at a second location, wherein training of the AI model occurs at the first location;
deploy the AI model at the second location;
automatically determine, by the executor component, validity of the certificate; and
upon determining that the certificate is invalid, automatically initiate an action on the AI model at the second location, the AI model being deployed at the second location, and independent of the device at the first location.

14. The network device of claim 13, wherein the executor component determines that the certificate is invalid after an expiration period, and wherein the expiration period is determined prior to receiving the AI model at the second location.

15. The network device of claim 13, wherein the processor further executes instructions to:
receive, by the executor component, a signal of a change in state from the device at the first location; and
determine that the certificate is invalid based on the signal of the change in state.

16. The network device of claim 13, wherein the AI model is generated at the first location by:
receiving an original AI model;
executing a hash function on the original AI model to generate a hash value;
generating an encrypted hash using a private key and the hash value;
providing the encrypted hash to a certificate authority to generate a certificate of the encrypted hash; and
publishing the AI model with the certificate.

17. The network device of claim 16, wherein the AI model and the certificate are published with a timestamp, and wherein the timestamp is used with determining the validity of the certificate.

18. The network device of claim 13, wherein the action comprises continuing access to the AI model for a pre-defined period of time at the second location.

19. The network device of claim 13, wherein the action comprises stopping processing immediately and transmitting a notification that the certificate is invalid.

20. The network device of claim 13, wherein the action comprises deleting the AI model by the executor component absent deleting other contents in the container.
